(19) United States
(12) Patent Application Publication
(10) Pub. No.: US 2011/0267181 A1
(43) Pub. Date: Nov. 3, 2011

(54) APPARATUS AND METHOD FOR PROVIDING TACTILE FEEDBACK FOR USER

(75) Inventor: Johan Kildal, Helsinki (FI)

(73) Assignee: Nokia Corporation

(21) Appl. No.: 12/770,265

(22) Filed: Apr. 29, 2010

(51) Int. Cl. G08B 6/00; G06F 3/041

(52) U.S. Cl. 340/407.2; 345/173

(57) ABSTRACT

In accordance with an example embodiment of the present invention, a method is provided for providing tactile feedback in response to a user input. Force sensing information associated with force to an input surface by an input object and detected by the force sensor is obtained and a tactile output actuator is controlled to produce tactile output imitating physical sensation associated with displacement of the input surface on the basis of the force sensing information.

### FIELD

The present invention relates to an apparatus and a method for providing tactile feedback in response to a user input.

### BACKGROUND

Touch screens are used in many portable electronic devices, for instance in gaming devices, laptops, and mobile communications devices. Touch screens are operable by a stylus or by finger. Typically the devices also comprise conventional buttons for certain operations.

Most visual displays on desktop, laptop and mobile devices have rigid two dimensional physical surfaces. Graphical user interfaces (GUIs) represent elements that the user can interact with (buttons, scroll bars, switches, etc.). Typically GUI elements are associated with two states. A user can experience the physical action of change in the binary state via the contact between finger/pen with the surface of the display. In some cases, such physical sensation is enhanced with bursts of vibration that signify the action of a bi-state physical button. For instance, many current mobile devices with touch display produce a haptic “click” when a GUI button is pressed.

### SUMMARY

Various aspects of examples of the invention are set out in the claims.

According to an aspect, an apparatus is provided, comprising at least one processor; and at least one memory including computer program code, the at least one memory and the computer program code configured to, with the at least one processor, cause the apparatus at least to perform: receive force sensing information associated with force to an input surface by an input object and detected by a force sensor, and control a tactile output actuator to produce tactile output imitating physical sensation associated with displacement of the input surface on the basis of the force sensing information.

According to an aspect, a method is provided, comprising: receiving force sensing information associated with force to an input surface by an input object and detected by the force sensor, and controlling a tactile output actuator to produce tactile output imitating physical sensation associated with displacement of the input surface on the basis of the force sensing information.

According to an embodiment, vibrotactile feedback is generated by real-time synthesis based on vibration parameters calculated at least on the basis of the force sensing information.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIGS. 1a and 1b illustrate an electronic device according to an embodiment of the invention;

FIG. 2 illustrates an apparatus according to an embodiment;

FIG. 3 illustrates a method according to an embodiment;

FIG. 4 illustrates a method according to an embodiment; and

FIG. 5 illustrates an interaction cycle according to an embodiment.

### DETAILED DESCRIPTION

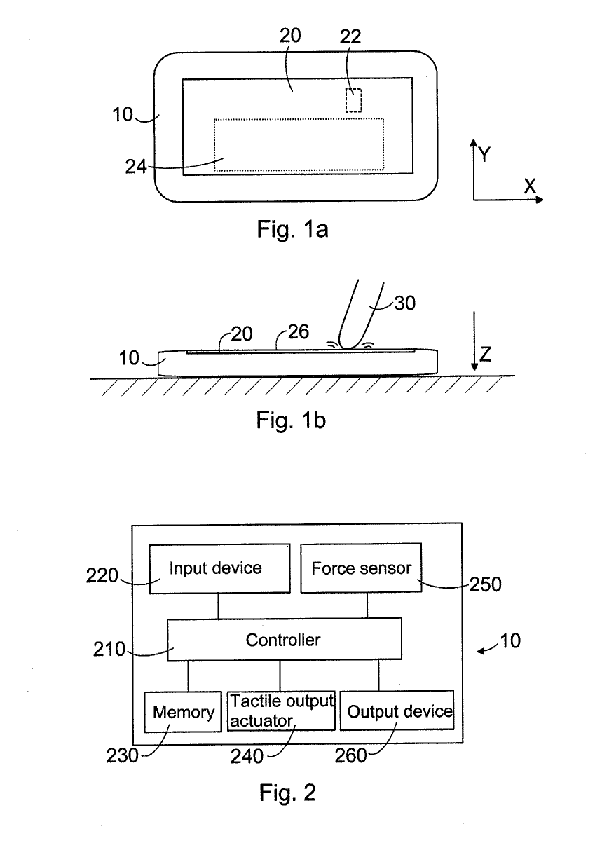

FIGS. 1a and 1b illustrate an electronic device 10 with one or more input devices 20. The input devices may for example be selected from buttons, switches, sliders, keys or keypads, navigation pads, touch pads, touch screens, and the like. For instance, the input device 20 could be provided at housing close to one or more input devices, such as a button or display, or as a specific input area on side(s) or back (in view of the position of a display) of a handheld electronic device. Examples of electronic devices include any consumer electronics device like computers, media players, wireless communications terminal devices, and so forth. In another embodiment the device 10 could be a peripheral device.

The input device 20 is configured to detect when an object 30, such as a finger or a stylus, is brought in contact with a surface 26 of the input device, herein referred to as an input surface.

An area or element 22, 24 of the input surface, such as a graphical user interface (GUI) element on a touch screen, can be interacted by accessing an X, Y location of the area or element on the input surface. The behaviour of such element in the Z axis (normal to the input surface) may be binary, presenting only two states. For instance, a virtual button has two possible states: pressed or not. Such change in state is normally achieved by accessing the corresponding X, Y location of the button on the display and performing an event action on it. However, it may be possible to have more than two states available in the Z direction.

A solution has now been developed to provide further enhanced tactile augmented feedback associated with pressing the object 30 substantially along the Z axis (perpendicular to the input surface) on the input surface 26. Tactile output imitating physical sensation associated with resistance of displacement of the input surface may be produced on the basis of force applied to the input surface 26. This facilitates sensation of feeling a substantially rigid surface as flexible or pliant when force is applied on it. A variety of mechanical properties of the augmented surface may be imitated by the tactile output.

The electronic device 10 may be configured to generate tactile output that resembles the resistance that the user's hand would feel if the input surface 26 being pressed was not rigid, but elastic or able to recede towards the inside of the surface for a certain distance. While the input surface 26 does not actually displace, the combination of the force applied that is felt on the skin, with the deformation of the skin towards the surface as more force is applied, and feeling imitated friction of the displacement in the Z axis (normal to the surface), may provide a compelling experience around various metaphors borrowed from the physical world. Thus, the user may be provided with an imitation of the physical sensation of pushing a GUI button or other element to many intermediate positions.

FIG. 2 illustrates a simplified embodiment of an apparatus according to an example embodiment. The units of FIG. 2 may be units of the electronic device 10, for instance. The apparatus comprises a controller 210 operatively connected to an input device 220, a memory 230, at least one tactile output actuator 240, and at least one force sensor 250. The controller 210 may also be connected to one or more output devices 260, such as a loudspeaker or a display.

The input device 220 comprises a touch sensing device configured to detect user's input. The input device may be configured to provide the controller 210 with signals when the object 30 touches the touch-sensitive input surface. Based on such input signals, commands, selections and other types of actions may be initiated, typically causing visible, audible, and/or tactile feedback for a user. The input device 220 is typically configured to recognize also the position of touches on the input surface. The touch sensing device may be based on sensing technologies including, but not limited to, capacitive sensing, resistive sensing, surface acoustic wave sensing, pressure sensing, inductive sensing, and optical sensing. Furthermore, the touch sensing device may be based on single point sensing or multipoint sensing. In some embodiments the input device 20, 220 is a touch screen.

The tactile output actuator 240 may be a vibrotactile device, such as a vibration motor, or some other type of device capable of producing tactile sensations for a user. For instance, linear actuators (electromechanical transducer coils that shake a mass), rotating-mass vibration motors, or piezo actuators can be used. However, also other current or future actuator technologies that produce vibration in the haptic range of frequencies may be used. It is possible to apply a combination of actuators that produce vibrations in one or more frequency ranges to create more complex variants of the illusion of flexible surface. For example, basic friction in the Z axis may be produced as combined with other punctual vibrations resembling collisions with bodies as the pressing element advances in the Z axis. Such further tactile output may be used to signify associated events. For instance, stronger “ticks” are produced when a push-button reaches the point of engagement at the bottom.

The actuator 240 may be embedded in the electronic device 10. In another embodiment the actuator is located outside the electronic device, for instance embedded in a stylus or pen used as the inputting object 30 (in which case also further elements 210, 250 for enabling the tactile output may be outside the device 10). The actuator 240 may be positioned closely to the input surface, for instance embedded in the input device 220. The source of actuation may be positioned such that the pressing finger feels tactile output to originate from the point of contact between finger or stylus and the input surface to most optimally provide illusion of flexible surface by the tactile feedback. However, the illusion can also work if the actuator 240 is located in other portions of electronic device 10. If the device is handheld, the vibration may be perceived by both hands.

The force sensor 250 is capable of detecting force applied by an object to (an area of) an input surface, which could also be referred to as the magnitude of touch. The force sensor 250 may be configured to determine real time readings of the force applied on the input surface and provide force reading or level information for the controller 210. For instance, the force sensor may be arranged to provide force sensing information within a range of ˜0 to 500 grams. It is to be noted that the force sensor may be a pressure sensor, i.e. further define pressure applied on the input surface on the basis of the detected force. The force sensor may be embedded in the input device 220, such as a touch screen. For instance, force may be detected based on capacitive sensing on a touch screen (the stronger the finger presses, the more skin area is in contact, and this area can be taken as a measure of the force applied). Various types of force sensors may be applied as long as they provide enough force sensing levels. Some non-limiting examples of available techniques include potentiometers, film sensors applying nanotechnology, force sensitive resistors, or piezoelectric sensing.

The controller 210 may be arranged to receive force sensing information associated with force caused by an input object 30 to the input surface 26 as detected by the force sensor 250. On the basis of the force sensing information, the controller 210 may be arranged to control the actuator 240 to produce tactile output, hereafter referred to as force-sensitive tactile output, imitating physical sensations associated with resistance of displacement of the input surface 26. The force sensing information refers generally to information in any form suitable for indicating magnitude and/or change of force or pressure detected to an input surface. The controller 210 may control the actuator 240 by generating a control signal for the actuator and sending the control signal to the actuator.

The control signal and the force-sensitive tactile output may be determined by further applying predetermined control data, such as parameters and/or profiles, stored in the memory 230. In one embodiment the apparatus is configured to determine the amount or level of force along the Z axis, and the apparatus is configured to determine parameters for the actuator in accordance with the amount or level of force caused by the input object towards the input surface. For the illusion of the physical sensation associated with resistance of displacement of the input surface to work effectively, the controller 210 is configured to maintain a close synchronization between the force sensing information and the excitation of the vibrotactile actuator(s) that the user senses directly on the skin or through a stylus or through the encasing (chasis) of the electronic device.

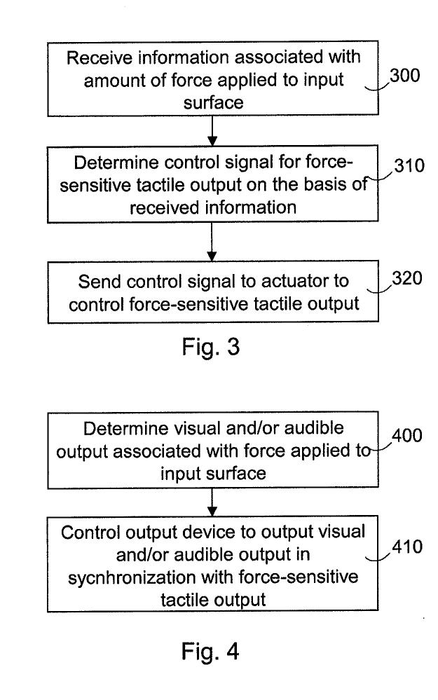

The controller 210 may be arranged to implement one or more algorithms providing an appropriate control to the actuator 240 on the basis of force applied towards the input surface 26. Some further embodiments for arranging such algorithms are illustrated below in connection with FIGS. 3 to 5.

Aspects of the apparatus of FIG. 2 may be implemented as an electronic digital computer, which may comprise memory, a processing unit with one or more processors, and a system clock. The processing unit is configured to execute instructions and to carry out various functions including, for example, one or more of the functions described in conjunction with FIGS. 3 to 5. The processing unit may be adapted to implement the controller 210. The processing unit may control the reception and processing of input and output data between components of the apparatus by using instructions retrieved from memory, such as the memory 230 illustrated in FIG. 2.

By way of example, the memory 230 may include a non-volatile portion, such as EEPROM, flash memory or the like, and a volatile portion, such as a random access memory (RAM) including a cache area for temporary storage of data. Information for controlling the functions of the apparatus could also reside on a removable storage medium and loaded or installed onto the apparatus when needed.

An embodiment provides a computer program embodied on a computer-readable medium. In the context of this document, a “computer-readable medium” may be any media or means that can contain, store, communicate, propagate or transport the instructions for use by or in connection with an instruction execution system, apparatus, or device, such as a computer, with one example of such apparatus described and depicted in FIG. 2. A computer-readable medium may comprise a non-transitory or tangible computer-readable storage medium that may be any media or means that can contain or store the instructions for use by or in connection with an instruction execution system, apparatus, or device, such as a computer. Computer program code may be stored in at least one memory of the apparatus, for instance the memory 230. The memory and the computer program code are configured, with at least one processor of the apparatus, to provide means for and cause the apparatus to perform at least some of the actuator control features illustrated below in connection with FIGS. 3 to 5 below. The computer program may be in source code form, object code form, or in some intermediate form. The actuator control features could be implemented as part of actuator control software, for instance.

The apparatus of an example embodiment need not be the entire electronic device 10 or comprise all elements of FIG. 2, but may be a component or group of components of the electronic device in other example embodiments. At least some units of the apparatus, such as the controller 210, could be in a form of a chipset or some other kind of hardware module for controlling an electronic device. The hardware module may form a part of the electronic device 10. Some examples of such a hardware module include a sub-assembly or an accessory device.

At least some of the features of the apparatus illustrated further below may be implemented by a single-chip, multiple chips or multiple electrical components. Some examples of architectures which can be used for the controller 210 include dedicated or embedded processor, and application-specific integrated circuits (ASIC). A hybrid of these different implementations is also feasible.

Although the units of the apparatus, such as the controller 210, are depicted as a single entity, different modules and memory may be implemented in one or more physical or logical entities. For instance, the controller 210 could comprise a specific functional module for carrying one or more of the steps in FIG. 3, 4, or 5. Further, the actuator 240 and the force sensor 250 are illustrated as single entities, and it will be appreciated that there may be a separate controller or interface unit for the actuator 240 (e.g. a motor driving unit) and the force sensor 250, to which the controller 210 may be connected.

It should be appreciated that the apparatus, such as the electronic device 10 comprising the units of FIG. 2, may comprise other structural and/or functional units, not discussed in more detail here. For instance, the electronic device 10 may comprise further interface devices, a battery, a media capturing element, such as a camera, video and/or audio module, and a user identity module, and/or one or more further sensors, such as one or more of an accelerometer, a gyroscope, and a positioning sensor.

In general, the various embodiments of the electronic device 10 may include, but are not limited to, cellular telephones, personal digital assistants (PDAs), graphic tablets, pagers, mobile computers, desktop computers, laptop computers, media players, televisions, imaging devices, gaming devices, media players, such as music and/or video storage and playback appliances, positioning devices, electronic books, electronic book readers, Internet appliances permitting Internet access and browsing. The electronic device 10 may comprise any combination of these devices.

In some embodiments, the apparatus is a mobile communications device comprising an antenna (or multiple antennae) in operable communication with at least one transceiver unit comprising a transmitter and a receiver. The apparatus may operate with one or more air interface standards and communication protocols. By way of illustration, the apparatus may operate in accordance with any of a number of first, second, third and/or fourth-generation communication protocols or the like. For example, the electronic device 800 may operate in accordance with wireline protocols, such as Ethernet and digital subscriber line (DSL), with second-generation (2G) wireless communication protocols, such as IS-136 (time division multiple access (TDMA)), Global System for Mobile communications (GSM), and IS-95 (code division multiple access (CDMA)), with third-generation (3G) wireless communication protocols, such as 3G protocols by the Third Generation Partnership Project (3GPP), CDMA2000, wideband CDMA (WCDMA) and time division-synchronous CDMA (TD-SCDMA), or with fourth-generation (4G) wireless communication protocols, wireless local area networking protocols, such as 802.11, short-range wireless protocols, such as Bluetooth, and/or the like.

Let us now study some embodiments related to controlling tactile feedback on the basis of force sensing information associated with force by an object to an input surface. Although embodiments below will be explained by reference to entities of FIGS. 1 and 2, it will be appreciated that the embodiments may be applied with various hardware configurations.

FIG. 3 shows a method for controlling force-sensitive tactile output according to an embodiment. The method may be applied as a control algorithm by the controller 210, for instance. The method starts in step 300, whereby force sensing information (directly or indirectly) associated with force caused by an input object to an input surface is received. For instance, the force sensing information may indicate the level of force or pressure detected by the force sensor 250 on the input surface 26.

Generation of tactile output imitating physical sensations associated with resistance of displacement of the input surface is controlled 310, 320 on the basis of the force sensing information. A control signal for force-sensitive tactile output may be determined 310 on the basis of received force sensing information and prestored control data associated with the currently detected amount of force, for instance. The control signal may be sent 320 to at least one actuator 240 to control force-sensitive tactile output.

The steps of FIG. 3 may be started in response to detecting the object 30 touching the input surface 26. The steps may be repeated to produce real-time force-sensitive feedback resembling physical sensation(s) related to displacement of an input surface along the Z axis to react to detected changes in force until the removal of the object 30 is detected. The user can thus decide (even by the present force-sensitive tactile feedback means alone) to displace the input surface to one of many perceived positions along a continuum in the Z axis.

In some embodiments the electronic device 10 is configured to produce reinforcing visual and/or audio output associated with the force sensing information or the tactile output in synchronization with the force-sensitive tactile output.

FIG. 4 illustrates a method according to an embodiment, in which visual and/or audible output directly or indirectly associated with the detected force on the input interface is determined 400. For instance, the controller 210 may select a specific audio signal associated with a received force level or a force-sensitive tactile output determined in step 310. In another example a specific GUI element is associated with a predefined range or amount of force.

In step 410 the output of the determined reinforcing visual and/or audio output is controlled in synchronization with the force-sensitive tactile output. Thus, the controller 210 may control the output device 260 by associated control signal at an appropriate time.

Such additional outputs may be referred to further (sensory) modalities and may be used to create multimodal events. The illusion of flexible surface can be “fine tuned” by combining it with other modalities that create a metaphor. Additionally, having congruent stimuli in different modalities eases usability in different contexts. For instance, if the user is wearing gloves, she does not necessarily feel the haptic illusion of a button entering the device and crossing various levels, but additional visual and/or audio representations of the same metaphor assist the user.

An area or element 22, 24, such as a physical area, a window or a GUI element, may be associated with force-sensitive tactile feedback operations. The force sensor 250 may be arranged to detect force information only regarding such area or element. The force sensing information may be associated with position information in the X and Y directions, i.e. information indicating the position of the object 30 on the input surface. The controller 210 may be configured to control the actuator 240 and the pressure-sensitive tactile output on the basis of such position information. For instance, one area or GUI element may be associated with different tactile output profile than another area or GUI element. For instance, virtual keys displayed on touch screen are associated with a force-sensitive feedback imitating physical sensations of pressing a conventional spring-mounted computer keypad button.

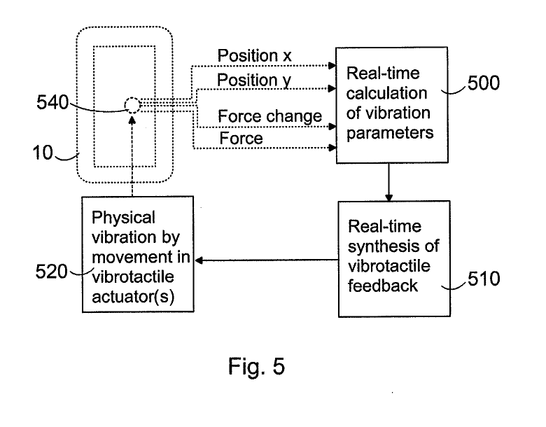

In some embodiments real-time synthesis is applied to generate force-sensitive vibrotactile feedback. FIG. 5 illustrates a real-time interaction cycle according to an embodiment, in which, besides force and/or force change information, position in the X axis and Y axis of the point of contact 540 is applied for real-time calculation 500 of vibration parameters. On the basis of the parameters, force-sensitive vibrotactile feedback may be synthesized 510 in real-time and provided for the user as physical vibration 520 by movement in vibrotactile actuator(s).

The detected change in force may be used to trigger the tactile output. The actual level of force may determine the properties of the tactile output that will be triggered. The illusion of movement in the Z axis arises from the fact that when the user pushes more strongly (while the change in force applied is taking place), friction-like feedback is produced. In this way, although there was no actual movement in the Z axis, the user's brain has enough reason to interpret that the increase in the force applied resulted in a movement in that axis (which had to overcome some friction). The same is true for the case in which the force applied is released, which would allow an elastic surface to return towards its position of rest, and thus the user may be provided with tactile output that imitates the physical sensation of the friction overcome by the elastic surface to return to its position of rest.

For the illusion to work, the electronic device may be arranged to control the change in force applied and perceiving tactile friction-like impulses to occur simultaneously and minimize latency. However, to an extent, latency can be used as a design parameter too to create some effects. Potentially any of audio synthesis techniques may be applied to feed audio waves at appropriate frequencies in the vibra actuator. For instance, subtractive synthesis, additive synthesis, granular synthesis, wavetable synthesis, frequency modulation synthesis, phase distortion synthesis, physical modelling synthesis, sample-based synthesis or subharmonic synthesis may be applied. In practice, these techniques may be used in a granular form: very short so-called grains of vibration (temporally short burst of vibration with a defined design regarding the properties of the vibration) are produced (only a few milliseconds long), so that the system is very responsive. The properties of these grains can be adapted on the basis of the current force, X, Y position etc.

The above-illustrated features may be applied for different applications and applications modes. For instance, the force-sensitive tactile output may be adapted according to a current operating state of the apparatus, a user input or an application executed in the apparatus. In one embodiment, a user may configure various settings associated with the force sensitive tactile feedback. For instance, the user may set the force sensitive feedback on and off or configure further parameters associated with the force sensitive tactile feedback.

Various physical sensations associated with applying force to physical objects may be imitated by the force-sensitive tactile feedback, some non-limiting examples being illustrated below.

In some embodiments the force-sensitive tactile output is associated with an item, such as a virtual button, displayed on a touch screen. The force-sensitive tactile output may be associated with various types of mechanical controls. The force-sensitive tactile output may be configured for providing illusion of pressing a button, such as a spring mounted push button with or without engaging mechanism at the bottom or a radio button with multiple steps of engagement. The force sensitive tactile output may also provide the illusion of pressing a mechanical actuator along a certain stoke length, with which some parameter or an application running in the device is controlled.

As some further examples, the controller 210 may be configured to control force-sensitive tactile feedback imitating one or more of the following: geometric block of material inside cavities with the same shape, along which they can be pushed further inside, membranes laid over various materials (sandy matter, foams etc.), and collapsible domes that break after the application of enough force, mechanical assemblies like hard material mounted on springs, hard materials that crack broken, foamy materials, gummy materials, rubbery materials, pliable materials, homogeneous materials, heterogeneous materials with granularity of hard bits inside which may vary in density and/or grain in size, cavernous materials with cavities that vary in density and/or shape, assemblies of various materials layered on top of each other, materials that can be compressed or materials that can be penetrated, different levels of depth in the interaction, different levels of elasticity and plasticity; different levels of roughness, smoothness, hardness, softness, responsiveness, and perceived quality. In general, the tactile output may be arranged to imitate natural or synthetic materials and mechanical assemblies that respond to the application of force on them in different ways.

By utilizing at least some of the above illustrated features, different mechanical behaviours can be imitated by varying the design of various parameters of the force-sensitive tactile feedback generation. In the discussion of these parameters, the term “grain” is used to refer to a small increment or reduction in the force applied (AF) which triggers a vibration grain. “Vibration grain” refers to a short, discrete tactile feedback generated in the tactile actuator(s) 240, which is designed to imitate one discrete burst of vibration in the succession of bursts of vibration that make the tactile sensation of friction associated to movement.

For instance, one or more of the following parameters may be varied:
Size of a grain, i.e. the magnitude of increase or reduction in the force applied (ΔF) that triggers a vibration grain
Distribution of grain sizes along the whole range of force used in the interaction
Frequency(ies) of the (base) vibration(s) in the tactile actuator(s) 240
Envelope form and amplitude of each vibration grain
Sub-range of the whole force range reported by the sensor 250. For instance, the amount of force that is necessary to build up before the imitated “movement” in the z-axis can start (before the first vibration grain is triggered) or the highest level of pressure that will permit an additional grain to be triggered by further increase in the force applied.
Differences in one or more of the above properties when the force is increasing vs. when it is decreasing
Alterations in the regularity of one or more of the above properties
Special complementary vibrotactile events. For instance, stronger clicks may be applied at the point of engaging and disengaging of engaging buttons. In another example related to the metaphor of collapsing domes, the vibrotactile event following the collapse does not depend on the user's force input immediately after the collapse
Variations in one of more of the above properties of vibration as a function of the speed of change of the force applied
Variations in one of more of the above properties of vibration as a function of the acceleration of change of the force applied
Threshold of initiation of movement at any intermediate value in the usable range of applied force and from a condition of constant force (F) applied, the ΔF required to trigger the first grain (which can be different from subsequent grains)
Any other parameter involved in the synthesis of signals that can drive a vibrotactile actuator and the variation of their values as a function of:
   Any of the attributes of user actions involved in the interaction
   Any of the simulated properties of any of the metaphors imitated

Various combinations of the above indicated parameters and further supplementary or context-related parameters or conditions may be applied for controlling 310 force-sensitive tactile feedback imitating physical sensations associated with (resistance of) displacement of the input surface.

In some embodiments the force sensing information is applied for controlling one or more further functions and units of the electronic device 10.

In one embodiment, the apparatus is further configured to determine a level of input on the basis of the information on the amount of force applied by the input object 30 to the input surface 26. A display operation may be controlled in accordance with the level of input, for instance a particular GUI element is displayed in response to detecting a predefined level of force being applied on an UI area 22, 24. Thus, there may be more than two available input options associated with a touch-sensitive UI area or element 22, 24 and selectable on the basis of amount of force applied.

Thus, a user can control a parameter through increasing or decreasing force applied to the input surface. An associated value can be increased or decreased by increasing or decreasing force, and that value can be maintained constant when the force is maintained essentially constant. In such a case, it can happen that, although the user is trying to maintain a certain level of pressure, she or he is actually changing it slightly. Then, the presently disclosed tactile output imitating friction may alert the user that the force applied is drifting and the user can correct it.

A broad range of functions is available for selection to be associated with an input detected by the present force sensitive detection system. The controller 210 may be configured to adapt the associations according to a current operating state of the apparatus, a user input or an application executed in the apparatus, for instance. For instance, associations may be application specific, menu specific, view specific and/or context specific.

In some embodiments at least some of the above-indicated features may be applied in connection with user interfaces providing 3D interaction, or sense of 3D interaction. For instance, the force-sensitive tactile output imitating physical sensation associated with resistance of displacement of the input surface may be used in connection with various auto-stereoscopic screens.

Although tactile feedback in connection with a single object 30 was illustrated above, it will be appreciated that the present features may be applied in connection with multiple objects and multi-touch input user interfaces.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. (canceled)

2. An apparatus, comprising:
at least one processor; and
at least one memory including computer program code,
the at least one memory and the computer program code configured to, with the at least one processor, cause the apparatus at least to perform:
receive force sensing information associated with force to an input surface by an input object and detected by a force sensor, and
control a tactile output actuator to produce tactile output imitating physical sensation associated with displacement of the input surface on the basis of the force sensing information.

3. (canceled)

4. The apparatus of claim 2, wherein the apparatus is configured to determine the amount of force along an axis perpendicular to the input surface, and
the apparatus is configured to determine parameters for the actuator to imitate the physical sensation associated with resistance of displacement of the input surface in accordance with the amount of force caused by the input object towards the input surface.

5. The apparatus of claim 2, wherein
the apparatus is further configured to determine a level of input on the basis of the force sensing information, and
the apparatus is configured to control a display operation in accordance with the level of input.

6. The apparatus of claim 2, wherein the force sensor is a multi-level force sensor and the force sensing information indicates the level of force.

7. The apparatus of claim 2, wherein the input surface is substantially rigid and the tactile output is configured for providing illusion of elastic surface.

8. The apparatus of claim 2, wherein vibrotactile feedback is generated by real-time synthesis based on vibration parameters calculated at least on the basis of the force sensing information.

9. The apparatus of claim 2, wherein the apparatus is configured to generate reinforcing visual and/or audio output associated with the force sensing information or the tactile output in synchronization with the tactile output.

10. The apparatus of claim 2, wherein the apparatus is a mobile communications device comprising a touch screen comprising the input surface, the force sensor being operatively coupled to the controller and configured to detect force to the input surface, and the tactile output actuator being operatively coupled to the controller and configured to produce the tactile output.

11. A method, comprising:
receiving force sensing information associated with force to an input surface by an input object and detected by the force sensor, and
controlling a tactile output actuator to produce tactile output imitating physical sensation associated with displacement of the input surface on the basis of the force sensing information.

12. The method of claim 11, wherein the amount of force along an axis perpendicular to the input surface is determined, and
parameters for the actuator to imitate the physical sensation associated with resistance of displacement of the input surface are determined in accordance with the amount of force caused by the input object towards the input surface.

13. The method of claim 11, further comprising:
determining a level of input on the basis of the force sensing information, and
controlling a display operation in accordance with the level of input.

14. The method of claim 11, wherein the force sensor is a multi-level force sensor and the force sensing information indicates the level of force.

15. The method of claims 11, wherein the input surface is substantially rigid and the tactile output is configured for providing illusion of elastic surface.

16. The method of claim 11, wherein vibrotactile feedback is generated by real-time synthesis based on parameters calculated at least on the basis of the force sensing information.

17. The method of claim 11, wherein reinforcing visual and/or audio output associated with the force sensing information or the tactile feedback is generated in synchronization with the tactile output.

18. A computer readable storage medium comprising one or more sequences of one or more instructions which, when executed by one or more processors of an apparatus, cause the apparatus to at least perform:
receive force sensing information associated with force to an input surface by an input object and detected by the force sensor, and
control a tactile output actuator to produce tactile output imitating physical sensation associated with displacement of the input surface on the basis of the force sensing information.

19. The computer readable storage medium of claim 16, comprising one or more sequences of one or more instructions for causing the apparatus to control generation of vibrotactile feedback by real-time synthesis based on parameters calculated at least on the basis of the force sensing information.
